(19) United States
(12) Patent Application Publication
(10) Pub. No.: US 2025/0305848 A1
(43) Pub. Date: Oct. 2, 2025

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventor: Sayaka TSUBOTA, Nagoya-shi (JP)

(73) Assignee: TOYOTA JIDOSHA KABUSHIKI KAISHA, Toyota-shi (JP)

(21) Appl. No.: 19/077,154

(22) Filed: Mar. 12, 2025

(30) Foreign Application Priority Data
Apr. 2, 2024 (JP) 2024-059681

(51) Int. Cl. G01C 21/36; G10L 15/183; G10L 15/30; H04N 7/18

(52) U.S. Cl. CPC G01C 21/3694; G10L 15/183; G10L 15/30; H04N 7/183

(57) ABSTRACT

An information processing apparatus comprising a controller configured to execute processing of displaying on a map a plurality of icons indicating positions of each vehicle at a plurality of times based on travelling history of one or more vehicles, and transmitting, when one of the plurality of icons is selected, a command to a vehicle corresponding to the selected icon to transmit an image captured at a time corresponding to the selected icon. The controller is further configured to execute processing of acquiring a first information regarding a report from a predetermined administrative agency that has received the report regarding an occurrence of an abnormal event, and displaying on the map a location where the abnormal event is estimated to have occurred based on the first information.

### CROSS REFERENCE TO THE RELATED APPLICATION

This application claims the benefit of Japanese Patent Application No. 2024-59681, filed on Apr. 2, 2024, which is hereby incorporated by reference herein in its entirety.

### BACKGROUND

### Technical Field

The present disclosure relates to an information processing apparatus, an information processing method, and a non-transitory storage medium.

### Description of the Related Art

There is known a technology for monitoring incidents, accidents, and etc. using a moving object equipped with a camera. For example, Patent Literature 1 discloses a system that uses a server apparatus to manage the history of vehicle driving positions and identifies vehicles equipped with drive recorders that are located in the vicinity of an informant.

### Citation list

### Patent Literature

Patent Literature 1: Japanese Patent Application Laid-Open No. 2023-019792

### SUMMARY

An object of the present disclosure is to provide a technique that can improve the convenience of a monitoring system using a vehicle.

One aspect of the present disclosure is an information processing apparatus. In this case, the information processing apparatus may be comprising controller configured to execute processing of:
displaying on a map a plurality of icons indicating positions of each vehicle at a plurality of times based on travelling history of one or more vehicles; and
transmitting, when one of the plurality of icons is selected, a command to a vehicle corresponding to the selected icon to transmit an image captured at a time corresponding to the selected icon,
wherein, the controller may be further configured to execute processing of:
acquiring a first information regarding a report from a predetermined administrative agency that has received the report regarding an occurrence of an abnormal event; and
displaying on the map a location where the abnormal event is estimated to have occurred based on the first information.

Another aspect of the present disclosure is an information processing method. In that case, the information processing method may be comprising following processing performed by a computer:
displaying on a map a plurality of icons indicating positions of each vehicle at a plurality of times based on travelling history of one or more vehicles; and
transmitting, when one of the plurality of icons is selected, a command to a vehicle corresponding to the selected icon to transmit an image captured at a time corresponding to the selected icon,
wherein, further comprising following processing performed by the computer:
acquiring a first information regarding a report from a predetermined administrative agency that has received the report regarding an occurrence of an abnormal event; and
displaying on the map a location where the abnormal event is estimated to have occurred based on the first information.

Other aspect of the present disclosure may be a program for causing a computer to execute the above mentioned information processing method, or a computer-readable storage medium non-transitorily storing the program.

According to the present disclosure, there is provided a technique that can improve the convenience of a monitoring system using a vehicle.

### BRIEF DESCRIPTION OF THE DRAWINGS

FIG. 1 is a diagram illustrating an overview of an example of a monitoring system according to an embodiment.

FIG. 2 is a diagram schematically illustrating an example of the configuration of the monitoring system according to the embodiment.

FIG. 3 is a diagram schematically illustrating an example of vehicle data, a vehicle data table, and a vehicle list.

FIG. 4 is a diagram for explaining a flow of identifying the occurrence point from the first information.

FIG. 5 is a diagram illustrating an example of a first map screen and a second map screen.

FIG. 6 is a flowchart illustrating an example of a processing routine executed by the terminal apparatus.

### DESCRIPTION OF THE EMBODIMENTS

In recent years, automobiles have become increasingly connected, with an increasing number of vehicles equipped with communication functions. Furthermore, an increasing number of vehicles are equipped with dashboard cameras such as drive recorders. In relation to this, a service is being considered that would enable designated institutions to access video captured by dashboard cameras (hereinafter sometimes referred to as “on-board video”), thereby aiding in the initial response to abnormal events such as incidents or accidents. With such a service, for example, when an abnormal event is to reported a predetermined administrative agency such as a police agency or a fire agency, on-board video footage can obtained from a vehicle that was traveling near the site where the abnormal event occurred around the time that the predetermined administrative agency received the report (hereinafter sometimes referred to as the “report time”). As a result, the predetermined administrative agency will be able to quickly grasp the situation on the scene.

As a system for providing the above-mentioned service, a system is known in which icons or the like representing the traveling positions of a plurality of vehicles at a predetermined time in the past are mapped onto a map and presented the map to an operator. The operator selects on the map a vehicle that was traveling near the scene at the report time. This allows a request to be made to the vehicle to provide on-board video. The operator can also view on-board video that may capture the scene.

However, in the above-mentioned system, the operator who received the report had to search for the location of the scene on the map. As a result, it can take time and effort to identify the vehicle that is most likely to be photographing the scene, leaving room for improvement in terms of convenience.

One aspect of the present disclosure is an information processing apparatus comprising a controller configured to execute processing of: displaying on a map a plurality of icons indicating positions of each vehicle at a plurality of times based on travelling history of one or more vehicles; and transmitting, when one of the plurality of icons is selected, a command to a vehicle corresponding to the selected icon to transmit an image captured at a time corresponding to the selected icon. The controller acquires a first information regarding a report from a predetermined administrative agency that has received the report regarding an occurrence of an abnormal event. The predetermined administrative agency is, for example, a police agency or a fire agency, which receives reports of abnormal events such as incidents or accidents, and dispatches staff to the scene of the occurrence of the abnormal event. In one example, the first information may include voice data of a conversation between an informant and the predetermined administrative agency. In another example, the first information may include text data obtained by performing voice recognition on a conversation between the informant and the predetermined administrative agency.

The controller of the information processing apparatus according to the present disclosure displays on a map a location where the abnormal event is estimated to have occurred (hereinafter, sometimes referred to as an “occurrence location”) based on the first information. Here, if the first information is voice data of a conversation between the informant and the predetermined administrative agency, the controller may identify the occurrence location by analyzing the voice data using a predetermined language model. In one example, the predetermined language model may be a language model trained by voice used when the predetermined administrative agency receives the report. In addition, if the first information is text data obtained by voice recognition of the conversation between the informant and the predetermined administrative agency, the controller may identify the location where the abnormal event is estimated to have occurred based on an address or the name of a landmark, etc., contained in the text data.

In addition, map on which occurrence location is displayed may display icons corresponding to vehicles that have been traveling within a predetermined range including the occurrence location within a predetermined period including the report time (e.g., within a period including a few minutes before and after the report time). In this case, the first information may include the report time.

According to the information processing apparatus of the present disclosure, the operator can quickly grasp a positional relationship between the occurrence location and vehicles that have been traveling near the occurrence location within predetermined period including report time by looking at map displaying multiple icons and occurrence location. As a result, the operator can easily identify the vehicle that is likely to have photographed the occurrence location. As a result, the operator can easily identify the vehicle that is likely to have photographed the occurrence location. This reduces the effort and time required to view on-board video that may capture the scene.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### Embodiment 1

### Overview of Monitoring System

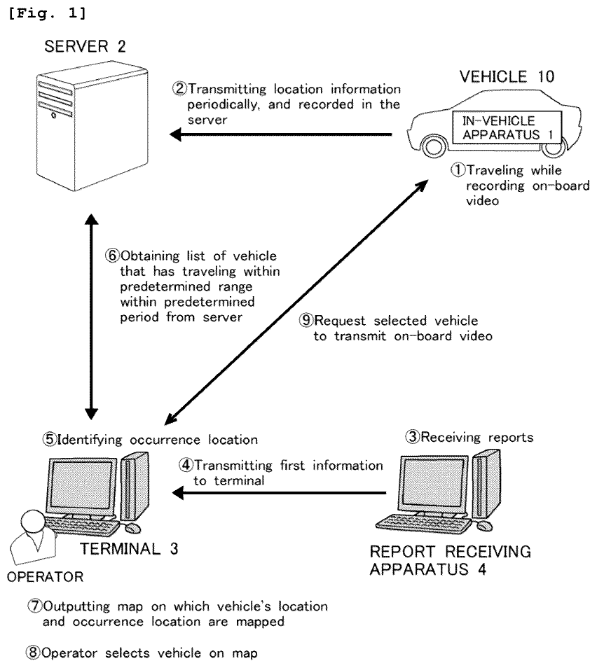

An overview of the monitoring system according to this embodiment will be described with reference to FIG. 1. The monitoring system according to this embodiment includes an in-vehicle apparatus 1 mounted on a vehicle 10, a server 2, a terminal 3, and a report receiving apparatus 4. In the example illustrated in FIG. 1, only one in-vehicle apparatus 1 (vehicle 10) is illustrated, but a plurality of in-vehicle apparatuses 1 (vehicles 10) are included in the monitoring system.

Each of the in-vehicle apparatus 1 is a computer configured to be able to communicate with server 2 via a wireless communication (e. g., network a cellular communication network). Each of the in-vehicle apparatus 1 functions as a drive recorder and as a wireless communication device. In detail, the in-vehicle apparatus 1 has a function of obtaining moving images (on-board video) of area in front of the vehicle using the camera 15 described below, a function of storing the obtained on-board video, and a function of periodically transmitting a location information of the vehicle 10 to the server 2. Furthermore, the in-vehicle apparatus 1 in this embodiment also has a function of providing the stored on-board video to the server 2 in response to a request from the server 2.

In this embodiment, the in-vehicle apparatus 1 has a wireless communication function, but a configuration in which a data communication module (hereinafter, DCM) for connecting components installed in the vehicle to a communication network may be installed in the vehicle 1 may also be adopted. That is, the in-vehicle apparatus 1 and the wireless communication device may be separate.

The server 2 is a computer configured to be able to communicate with a plurality of vehicles 10 under the control of the monitoring system via a communication network. The server 2 has a function of periodically obtaining location information from each of the multiple vehicles 10 under the control of the monitoring system, and a function of storing the obtained location information. In addition, server 2 in this embodiment also has the function of providing terminal 3 with a list of vehicles 10 that have been traveling within a predetermined range within a predetermined period (hereinafter, sometimes referred to as a “vehicle list”) in response to a request from terminal 3. The predetermined period is a period including the report time which will be described later and approximately three minutes before and after the report time. The predetermined range is a geographical range including the occurrence location which will be described later. In one example, the predetermined range may be an area within 100 meters of the occurrence location. Furthermore, server 2 in this embodiment also has the function of acquiring on-board video from the vehicle 10 selected by an operator of the terminal 3 in response to a request from terminal 3, and providing the acquired on-board video to the terminal 3.

The terminal 3 has the function of acquiring the vehicle list from the server 2 by triggering the receipt of the first information transmitted from a report receiving apparatus 4 described later. Specifically, the terminal 3 identifies a location (occurrence location) that is estimated to be the scene where the abnormal event occurred, based on the first information received from the report receiving apparatus 4. In this embodiment, the first information includes the time (report time) at which an operator of the report receiving apparatus 4 received a report regarding the occurrence of an abnormal event, and voice data of the conversation between the operator of the report receiving apparatus 4 and an informant. In response to this, the terminal 3 identifies an occurrence location by analyzing the voice data included in the first information. The occurrence location in this embodiment is information indicating the position of a point that is estimated to be the scene where an abnormal event occurred. In one example, the occurrence location may be the latitude and longitude of the scene where the abnormal event is estimated to have occurred. As another example, the occurrence location may be the address of a location where the scene where the abnormal event occurred is estimated. When the occurrence location is identified in this manner, the terminal 3 transmits a request signal (hereinafter, sometimes referred to as a “first request signal”) to the server 2 to request the vehicle list. The first request signal in this embodiment includes information specifying the predetermined period (e.g., a period from three minutes before to three minutes after the report time) and information specifying the predetermined range (e.g., an area within 100 meters of the occurrence location).

In addition, the terminal 3 in this embodiment also has a function of outputting a first map screen in response to receiving the vehicle list transmitted from the server 2. The first map screen is a user interface screen on which the occurrence location and the positions of the vehicles 10 included in the vehicle list are mapped on a map of a predetermined range. The first map screen will be described in detail later. Furthermore, the terminal 3 in this embodiment also has a function of accepting an operator's selection operation of a vehicle 10 on the first map screen and transmitting a request signal (hereinafter sometimes referred to as a “second request signal”) requesting the on-board video of the selected vehicle 10 to the server 2. The second request signal in this embodiment includes information for identifying the selected vehicle 10, and information for identifying date and time when the selected vehicle 10 captured the on-board video. When the server 2 provides the on-board video to the terminal 3 in response to the second request signal, the terminal 3 plays back the provided on-board video.

The above-mentioned terminal 3 is placed in a predetermined administrative agency. The predetermined administrative agency in this embodiment is an agency that receives reports regarding the occurrence of abnormal events and dispatches staffs to the scene where the abnormal event occurred. Abnormal events include incidents and accidents.

In one example, the predetermined administrative agency may be a police agency. In this case, the terminal 3 can output the first map screen in response to a report to emergency services, and can also obtain and play back the on-board video of the vehicle 10 selected by the operator. This will enable the operator of the police agency to grasp the situation at the scene where an abnormal event occurs. In another example, the predetermined administrative agency may be a fire agency. In this case, the terminal 3 can output the first map screen in response to a report regarding a firefighting or an emergency, and can also obtain and play back the on-board video of the vehicle 10 selected by the operator. This enables the operator of the fire agency to grasp the situation at the scene where an abnormal event occurs.

Next, the report receiving apparatus 4 is a computer having a function of receiving the report regarding the occurrence of the abnormal event and transmitting the first information to the terminal 3. Specifically, upon receiving the report from the informant, the report receiving apparatus 4 records the time which the report was received (report time) and also records the conversation (phone call) between the operator and the informant. The report receiving apparatus 4 is triggered by the end of the call between the operator and the informant to transmit the first information including the recorded report time and the recorded voice data of the conversation to the terminal 3.

The above-mentioned report receiving apparatus 4, like the terminal 3, is placed in the predetermined administrative agency. The report receiving apparatus 4 may be placed in a department that has jurisdiction over an entire prefecture or the like, and the terminal 3 may be placed in a department that has jurisdiction over each area within the prefecture. In this case, the operator may input into the report receiving apparatus 4 an department that has operation to designate the the scene where the abnormal event jurisdiction over occurred. Then, the report receiving apparatus 4 may transmit the first information to the terminal 3 located in the designated department.

### Configuration of Monitoring System

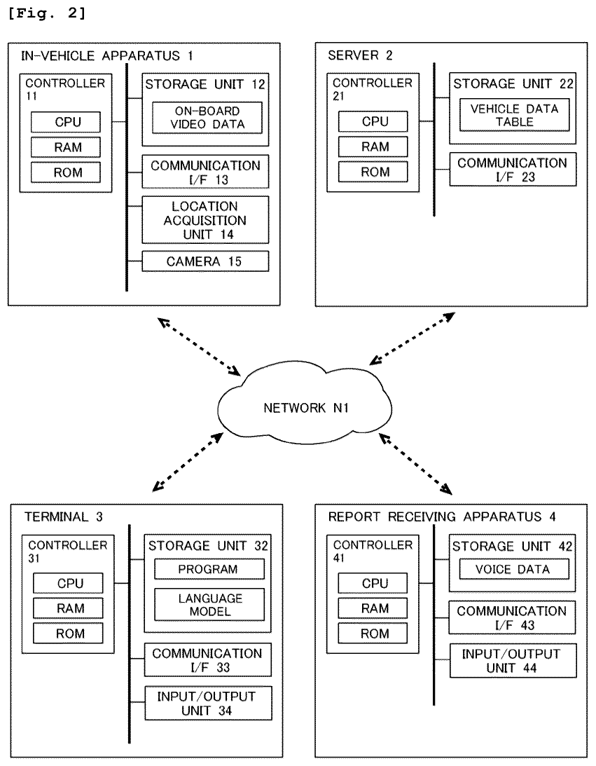

Next, the configuration of the monitoring system will be described with reference to FIG. 2. FIG. 2 is a diagram illustrating an example of the configuration of the monitoring system.

The in-vehicle apparatus 1 can be configured as a computer having a processor (CPU, GPU, etc.), a main memory (RAM, ROM, etc.), and an auxiliary memory (EPROM, hard disk drive, removable media, etc.). The auxiliary memory stores an operating system (OS), various programs, various tables, etc. The processor of the in-vehicle apparatus 1 executes the programs stored in the auxiliary memory to function matches achieve each that a predetermined purpose, as described below. Incidentally, some or all of the functions of the in-vehicle apparatus 1 may be realized by a hardware circuit such as an ASIC (Application Specific Integrated Circuit) or an FPGA (Field Programmable Gate Array).

The in-vehicle apparatus 1 according to this embodiment, as illustrated in FIG. 2, is configured to include controller 11, storage unit 12, a communication I/F 13, a location acquisition unit 14, and a camera 15.

The controller 11 is a calculation unit that realizes various functions of the in-vehicle apparatus 1 by executing a predetermined program. The controller 11 can be realized by, for example, a hardware processor such as a CPU. Furthermore, the controller 11 may be configured to include a RAM, a ROM (Read Only Memory), a cache memory, and the like.

The storage unit 12 is a module for storing information, and is configured with storage media such as RAM, a magnetic disk, and a flash memory. The storage unit 12 stores the programs executed by the controller 11, data used by the programs, and the like. The storage unit 12 in this embodiment also stores data of on-board videos captured by the camera 15 (on-board video data).

The communication I/F 13 is a wireless communication interface for connecting the in-vehicle apparatus 1 to the communication network N1. The communication I/F 13 is connected to the communication network N1 via, for example, a wireless LAN or a cellular communication network (for 4G, or example, 3G, 5G, etc.), and communicates with the server 2 through the communication network N1. The communication network N1 may be, for example, a Wide Area Network (WAN), which is a global public communication network such as the Internet, or other communication network.

The location acquisition unit 14 obtains location information of the vehicle 10. The location acquisition unit 14 includes a GPS antenna and a positioning module for measuring location information. A GPS antenna is an antenna that receives positioning signals transmitted from positioning satellites (also called GNSS satellites). The positioning module is a module that calculates location information based on the signal received by the GPS antenna. The location acquisition unit 14 may determine the traveling direction of the vehicle 10 based on the transition of the location information.

The camera 15 is an optical device including an image sensor for obtaining images. The camera 15 is mounted, for example, facing forward of the vehicle 10.

In the in-vehicle apparatus 1 configured as described above, the controller 11 uses the camera 15 to capture video (on-board video) while the vehicle 10 is traveling and/or parked. The controller 11 stores the on-board video data captured by the camera 15 in the storage unit 12. The on-board video data includes a plurality of on-board video files. In this embodiment, each on-board video file is associated with an identifier (date and time ID) for identifying the date and time when the on-board video file was generated (i.e., the date and time when the on-board video was captured). The date and time ID may uniquely identify the year, month, day, hour, minute, and second. The controller 11 operates in this manner, so that the in-vehicle apparatus 1 functions as a drive recorder.

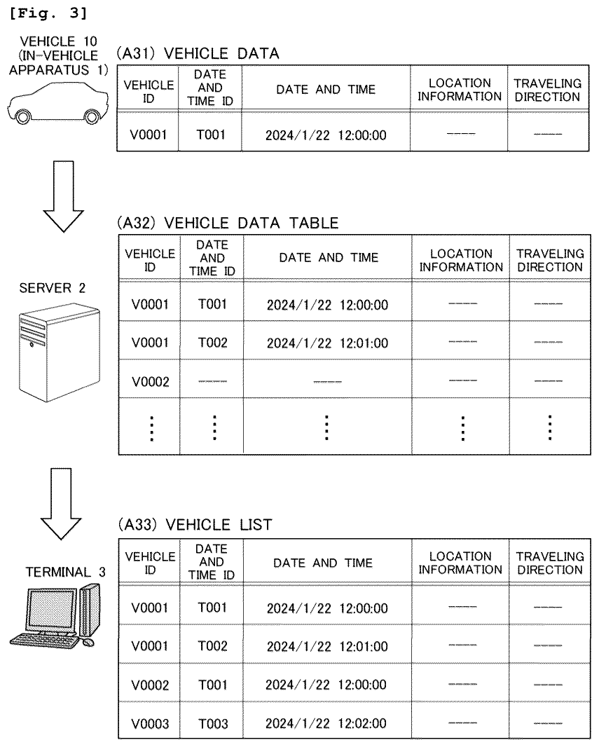

In addition, in the in-vehicle apparatus 1, the controller 11 periodically generates data related to the traveling of the vehicle 10 (hereinafter, sometimes referred to as “vehicle data”) and transmits the data to the server 2. In one example, the vehicle data may include, as indicate (A31) in FIG. 3, a vehicle ID that uniquely identifies vehicle 10, a date and time ID that identifies the date and time when the location information of vehicle 10 was acquired, the date and time when the location information of vehicle 10 was acquired, the location information of vehicle 10, and the direction of travel of vehicle 10. The location information and traveling direction to be included in the vehicle data obtained by the controller 11 through the location acquisition unit 14. The vehicle data is generated and transmitted at a predetermined interval. In one example, the predetermined period may be a timing linked to the generation of the on-board video file. That is, each time a new on-board video file is generated, the controller 11 may generate and transmit vehicle data. In this case, the date and time included in the vehicle data (the date and time when the location information of the vehicle 10 obtained) will be the same as the date and time when the on-board video file was newly generated (the date and time when the on-board video was captured).

Furthermore, in the in-vehicle apparatus 1, the controller 11 transmits the on-board video file to the server 2 in response to a third request signal, which will be described later, transmitted from the server 2. Specifically, the controller 11 accesses the on-board video data in the storage unit 12 using the date and time ID included in the third request signal as an argument, and extracts a video file associated with a date and time ID that matches the date and time ID. The controller 11 transmits the extracted on-board video file to the server 2 via the communication I/F 13.

Next, the server 2 will be described. The server 2 can be, like the in-vehicle apparatus 1, configured as a computer having a processor (CPU, GPU, etc.), a main memory (RAM, ROM, etc.), and an auxiliary memory (EPROM, hard disk drive, removable media, etc.).

In this embodiment, as illustrated in FIG. 2, the server 2 is configured to include controller 21, storage unit 22, and communication I/F 23.

The controller 21 is a computing module that realizes various functions of the server 2 by executing a predetermined program. The controller 21 can be realized by, for example, a hardware processor such as a CPU. Furthermore, the controller 21 may be configured to include a RAM, a ROM (Read Only Memory), a cache memory, and the like.

The storage unit 22 is a module that stores information, and is configured with storage media such as RAM, a magnetic disk, and a flash memory. The storage unit 22 stores the programs executed by the controller 21, data used by the programs, and the like. The storage unit 22 in this embodiment also stores a table (hereinafter, sometimes referred to as a “vehicle data table”) in which vehicle data transmitted from each of the multiple vehicles 10 under the management of the monitoring system is registered.

The communication I/F 23 is a communication interface for connecting the server 2 to the communication network N1. The communication I/F 23 is connected to the communication network N1 via, for example, Ethernet (registered trademark), a wireless LAN, or a cellular and communicates with the in-communication network, vehicle apparatus 1 and the terminal 3 through the communication network N1.

In the server 2 configured as described above, the controller 21 periodically receives vehicle data from each of the multiple vehicles 10 (in-vehicle apparatus 1) under the control of the monitoring system. The controller 21 stores the received vehicle data in the vehicle data table in the storage unit 22. In this case, the vehicle data table may be, for example, a table in which a plurality of vehicle data received from a plurality of vehicles 10 are stored by record, as indicated (A32) in FIG. 3.

In addition, in server 2, controller 21 provides information to terminal 3 based on the information stored in the vehicle-specific records in storage unit 22. Providing information from the server 2 to the terminal 3 includes providing the vehicle list, and providing the on-board video file.

The vehicle list is provided in response to the communication I/F 23 receiving the first request signal transmitted from the terminal 3. Specifically, the controller 21 compares the predetermined period included in the first request signal with the date and time registered in the date and time field of each record in the vehicle data table, and identifies records in which the date and time registered in the date and time field falls within the predetermined period. The controller 21 compares the location information registered in the location information field of the identified record with a predetermined range included in the first request signal, and extracts records whose location information registered in the location information field is included in the predetermined range. The controller 21 generates a list (vehicle list) of vehicles 10 that have traveled within the predetermined range within the predetermined period, based on the extracted records. In one example, the vehicle list may be a list of records extracted from the vehicle data table, as indicate (A33) in FIG. 3. It should be noted that the records included in the vehicle list may include the same vehicle 10. For example, the same vehicle 10 may transmit vehicle data multiple times within the predetermined range within the predetermined period. In this case, multiple records with the same vehicle ID may be included in the vehicle list. The vehicle list generated in this manner is transmitted to the terminal 3 via the communication I/F 23.

The provision of the on-board video file is executed in response to the communication I/F 23 receiving the second request signal transmitted from the terminal 3. In addition, the second request signal in this embodiment includes a vehicle ID that identifies the vehicle 10 selected by the operator of the terminal 3, and a date and time ID that identifies the date and time when the location information of the vehicle 10 selected by the operator of the terminal 3 was obtained (the date and time when the on-board video file was generated). When such a second request signal is received by the communication I/F 23 of the server 2, the controller 21 of the server 2 transmits a third request signal to the in-vehicle apparatus 1 of the vehicle 10 corresponding to the vehicle ID included in the second request signal. The third request signal is a signal requesting the provision of an on-board video file corresponding to the date and time ID included in the second request signal. Then, when the communication I/F 23 receives the on-board video file transmitted from the in-vehicle apparatus 1 response to the third request signal, the controller 21 of the server 2 transmits the received on-board video file to the terminal 3.

Next, the terminal 3 will be described. The terminal 3 can be, like the in-vehicle apparatus 1 and the server 2, configured as a computer having a processor (CPU, GPU, etc.), a main memory (RAM, ROM, etc.), and an auxiliary memory (EPROM, hard disk drive, removable media, etc.).

As indicate FIG. 2, the terminal 3 in this embodiment includes a controller 31,. storage unit 32, a communication I/F 33, and an input/output unit 34.

The controller 31 of the terminal 3 is a calculation unit that realizes various functions of the terminal 3 by executing a predetermined program. The controller 31 can be realized by, for example, a hardware processor such as a CPU. Furthermore, the controller 31 may be configured to include a RAM, a ROM (Read Only Memory), a cache memory, and the like.

The storage unit 32 is a module for storing information, and is configured with a storage medium such as a RAM, a magnetic disk, or a flash memory. The storage unit 32 stores the programs executed by the controller 31, data used by the programs, and the like. The programs stored in the storage unit 32 include application programs that correspond to the “programs” according to the present disclosure. Moreover, the storage unit 32 in this embodiment stores a language model. The language models stored in the storage unit 32 will be described in detail later.

The communication I/F 33 is a communication interface for connecting the terminal 3 to the communication network N1. The communication I/F 33 is connected to the communication network N1 via, for example, Ethernet (registered trademark), a wireless LAN, or a cellular communication network, and communicates with the server 2 and the report receiving apparatus 4 through the communication network N1.

The input/output unit 34 receives input from an operator of the terminal device 3 and presents information to the operator. Specifically, the input/output unit 34 includes a touch panel and its control module, and a liquid crystal display and its control module. In this embodiment, the touch panel and the liquid crystal display are configured as one touch panel display. The input/output unit 34 may include input devices such as a keyboard and a mouse in addition to the touch panel display.

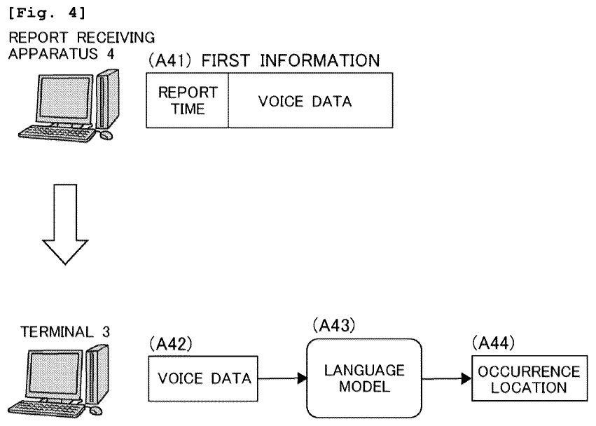

In terminal 3 configured as described above, controller 31 transmits a first request signal to server 2 in response to communication I/F 33 receiving first information transmitted from the report receiving apparatus 4 described below. Specifically, the controller 31 identifies the occurrence location in accordance with the first information. In this embodiment, as indicate (A41) in FIG. 4, first information indicates the time (report time) at which the operator of the report receiving apparatus 4 received report regarding the occurrence of an abnormal event, and voice data of the conversation between the operator of the report receiving apparatus 4 and an informant. As indicate (A42)-(A44) in FIG. 4, controller 31 analyzes the voice data included in the first information ((A42) in FIG. 3) using a language model ((A43) in FIG. 4) stored in storage unit 32 to identify the occurrence location ((A44) in FIG. 4). The occurrence location is the location (position) that is estimated to be the scene where the abnormal event occurred. In one example, the language model is a model trained on the speech of the report received by a government agency. The language model may be a model that takes voice data as input and outputs the geographic coordinates (latitude and longitude) or address of the occurrence location.

The first information may include text data obtained by performing voice recognition on the conversation between the operator of the report receiving apparatus 4 and the informant, instead of the voice data. In this case, the controller 31 of the terminal 3 may identify the occurrence location based on the address, or the name of a landmark included in the text data.

When the occurrence location is identified as described above, the controller 31 of the terminal 3 generates a first request signal. The controller 31 transmits the generated first request signal to the server 2. The first request signal in this embodiment includes information specifying a predetermined period (e.g., the period from three minutes before to three minutes after the report time included in the first information) and information specifying a predetermined range (e.g., an area within 100 meters of the occurrence location).

In the terminal 3, when the communication I/F 33 receives the vehicle list transmitted from the server 2 in response to the first request signal, the controller 31 outputs the first map screen to the input/output unit 34. The first map screen is a user interface (GUI) for requesting acquisition of on-board video. The first map screen includes an image in which an icon representing the location of the vehicle 10 included in the vehicle list obtained from the server 2 and the identified occurrence location are mapped onto a road map image within the aforementioned predetermined range.

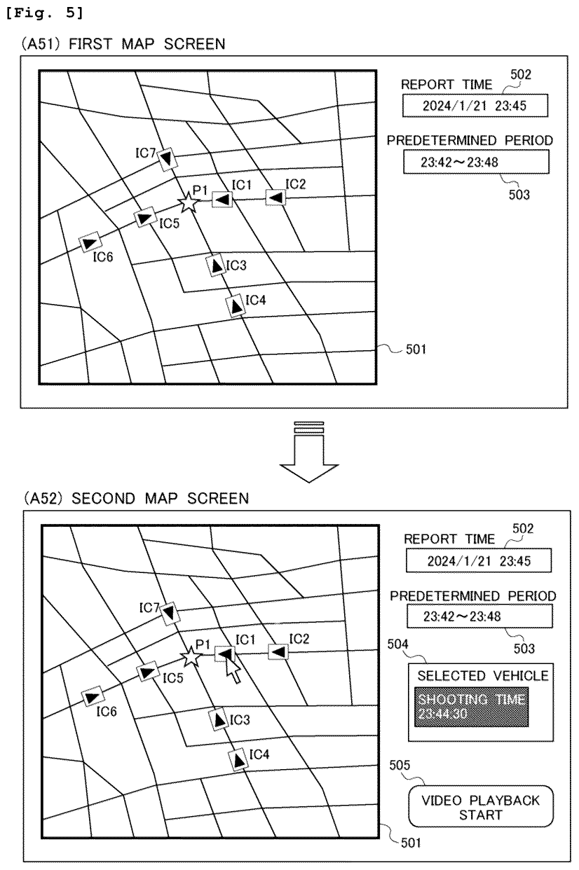

In one example, as indicate (A51) in FIG. 5, the first map screen includes a road map image within a predetermined range (501 in FIG. 5), a GUI component indicating the report time (502 in FIG. 5), and a GUI component indicating a predetermined period (503 in FIG. 5). Additionally, icons (IC1-IC7 in FIG. 5) indicating the locations of the vehicles 10 included in the vehicle list and the occurrence location (P1 in FIG. 5) are mapped onto a road map image (501 in FIG. 5) within a predetermined range. An icon of the vehicle 10 (IC1-IC7 in FIG. 5) is generated for each record in the vehicle list. That is, the same vehicle 10 may be represented by two or more icons. Note that, since the differences between the vehicles are not important to the operator, information for identifying the vehicles may not be displayed on the screen. The icons of the vehicles 10 (IC1-IC7 in FIG. 5) may be configured so that the traveling direction of the vehicle 10 can be identified.

When the operator of the terminal 3 selects any one of the icons while the first map screen is being output to the input/output unit 34, the controller 31 outputs the second map screen to the input/output unit 34 instead of the first map screen. In one example, as indicate (A52) in FIG. 5, the second map screen includes, a GUI component (504 in FIG. 5) indicating the time (shooting time) when the on-board video was captured in the vehicle 10 corresponding to the icon selected on the first map screen (in the example of (A52) in FIG. 5, icon (IC1) is selected), and a GUI component (505 in FIG. 5) indicating a video playback start button for requesting the start of playback of the on-board video captured in the vehicle 10 corresponding to the icon selected on the first map screen, in addition to a road map image within the predetermined range (501 in FIG. 5), a GUI component indicating the reporting time (502 in FIG. 5), and a GUI component indicating a predetermined period (503 in FIG. 5). The shooting time displayed in the GUI component (504 in FIG. 5) may be the time registered in the date and time field of the record corresponding to the icon (IC1 in FIG. 5) in the record included in the vehicle list.

When the second map screen is output to the input/output unit 34, if the operator of the terminal 3 inputs an operation to press (e.g., tap or click) the video playback start button (505 in FIG. 5) into the input/output unit 34, the controller 31 of the terminal 3 generates a second request signal. The controller 31 transmits the generated second request signal to the server 2. In this case, the second request signal includes the vehicle ID registered in the vehicle ID field of the record corresponding to the icon (IC1 in FIG. 5) and the date and time ID registered in the date and time ID field of the record corresponding to the icon (IC1 in FIG. 5).

Note that, although the second map screen of this embodiment has a video playback start button (505 in FIG. 5) as indicate (A52) in FIG. 5, the generation and the transmission of a second request signal may be executed in response to the selected icon (IC1 in FIG. 5) being tapped or clicked again.

When the communication I/F 33 receives the on-board video file transmitted from the server 2 in response to the second request signal, the controller 31 of the terminal 3 plays back the received on-board video file.

Returning to the explanation of FIG. 2, the report receiving apparatus 4 will now be described. The report receiving apparatus 4 can be, like in-vehicle apparatus 1, configured as a computer having a processor (CPU, GPU, etc.), main memory (RAM, ROM, etc.), and auxiliary memory (EPROM, hard disk drive, removable media, etc.).

In this embodiment, as illustrated in FIG. 2., the report receiving apparatus 4 includes controller 41, storage unit 42, communication I/F 43, and input/output unit 44.

The controller 41 is a calculation unit that realizes various functions of the report receiving apparatus 4 by executing a predetermined program. The controller 41 can be realized by, for example, a hardware processor such as a CPU. Furthermore, the controller 41 may be configured to include a RAM, a ROM (Read Only Memory), a cache memory, and the like.

The storage unit 42 is a module for storing information, and is configured with a storage medium such as a RAM, a magnetic disk, or a flash memory. The storage unit 42 stores the programs executed by the controller 41, data used by the programs, and the like. The storage unit 42 in this embodiment stores the voice data of the conversation between the informant regarding the occurrence of the abnormal event and the operator of the report receiving apparatus 4.

The communication I/F 43 is a communication interface for connecting the report receiving apparatus 4 to the communication network N1. The communication I/F 43 is connected to the communication network N1 via, for example, Ethernet (registered trademark), a wireless LAN, or a cellular communication network, and communicates with the terminal 3 through the communication network N1. The communication I/F 43 in this embodiment also includes a communication interface for connecting to a telephone communication network. The communication I/F 43 communicates (voice calls) with the informant's terminal (such as a landline phone or a mobile phone) via a telephone network.

The input/output unit 44 receives input from the operator of the report receiving apparatus device 4 and presents information to the operator. Specifically, the input/output unit 44 includes a touch panel and its control module, and a liquid crystal display and its control module. In this embodiment, the touch panel and the liquid crystal display are formed by one touch panel display. The input/output unit 34 may include input devices such as a keyboard and a mouse in addition to the touch panel display.

In the report receiving apparatus 4 configured as described above, the communication I/F 43 receives the report from the informant. When the communication I/F 43 receives the above-mentioned report, the controller 41 records the time when the report was received (report time) in the storage unit 42. Furthermore, the controller 41 records the conversation (phone call) between the operator of the report receiving apparatus 4 and the informant, and stores the recorded voice data in the storage unit 42. When the call between the operator and the informant ends, the controller 41 transmits the first information including the recorded voice data and the report time to the terminal 3. Note that, in a case where the monitoring system includes multiple terminals 3, the controller 41 may transmit the first information to the terminal 3 designated by the operator (the terminal 3 located in the department that has jurisdiction over the scene where the abnormal event occurred).

### Processing Flow

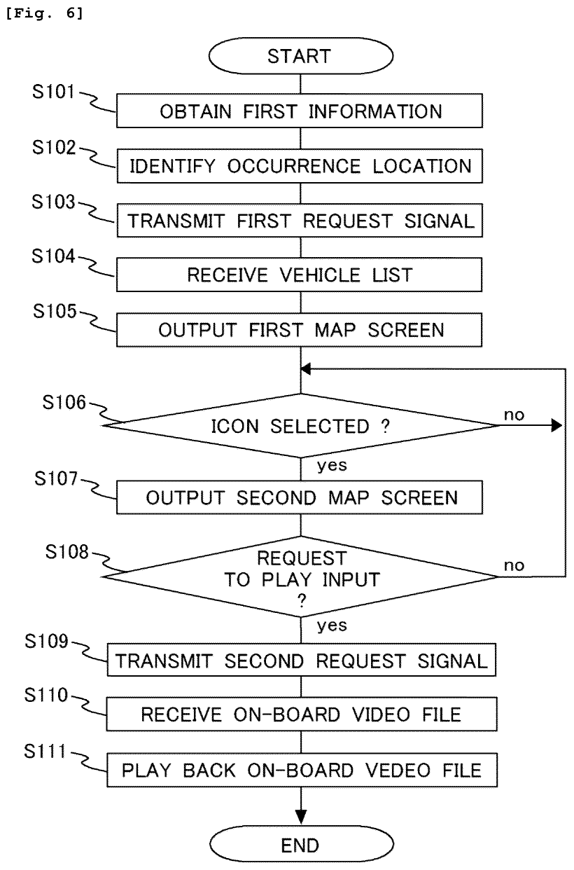

Here, the flow of processing executed by the terminal 3 in this embodiment will be described with reference to FIG. 6. FIG. 6 is a flowchart illustrating an example of a processing routine executed by the terminal device 3 when the terminal device 3 receives the first information transmitted from the report receiving apparatus 4.

In FIG. 6, when the communication I/F 33 of the terminal 3 receives the first information transmitted from the report receiving apparatusing device 4, the controller 31 of the terminal 3 obtains the first information through the communication I/F 33 (step S101). After completing the process of step S101, the controller 31 executes a process of step S102.

In step S102, controller 31 identifies the occurrence location by using the voice data included in the first information and the language model stored in the storage unit 32, as described above in the description of FIG. 4. After completing the process of step S102, the controller 31 executes a process of step S103.

In step S103, the controller 31 generates a first request signal according to the report time included in the first information and the occurrence location identified in step S102, and transmits the generated first request signal to the server 2. As described above, the first request signal includes information specifying a predetermined period including the report time (e.g., the period from three minutes before to three minutes after the report time included in the first information) and information specifying a predetermined range including the occurrence location (e.g., an area within 100 meters of the occurrence location). After completing the process of step S103, the controller 31 executes a process of step S104.

In step S104, the controller 31 receives, via the communication I/F 33, the vehicle list transmitted from the server 2 in response to the first request signal. As described above, the vehicle list is a list of vehicles 10 that have a history of traveling within a predetermined range within a predetermined period. After completing the process of step S104, the controller 31 executes a process of step S105.

In step S105, the controller 31 generates the first map screen in accordance with the vehicle list received in step S104, and outputs the generated first map screen to the input/output unit 34. As described above in the explanation of FIG. 5 ((A51) in FIG. 5), the first map screen includes a road map image within a predetermined range (501 in FIG. 5), a GUI component indicating the report time (502 in FIG. 5), and a GUI component indicating a predetermined period (503 in FIG. 5). At this time, icons (IC1-IC7 in FIG. 5) indicating the locations of the vehicles 10 included in the vehicle list and the occurrence location (P1 in FIG. 5) are mapped onto the road map image (501 in FIG. 5). After completing the process of step S105, the controller 31 executes a process of step S106.

In step S106, the controller 31 determines whether the operator of the terminal 3 has input an operation (e. g., a tap or click) to select one of the icons (IC1-IC7 in FIG. 5) on the first map screen to the input/output unit 34. If the operation to select any one of the icons (IC1-IC7 in FIG. 5) on the first map screen is not input to input/output unit 34 (negative determination in step S106), controller 31 waits until the operation is input. On the other hand, if an operation to select any one of the icons (IC1-IC7 in FIG. 5) on the first map screen is input to input/output unit 34 (positive determination in step S106), controller 31 executes processing in step S107.

In step S107, controller 31 generates the second map screen according to the icon (IC1-IC7 in FIG. 5) selected in step S106, and outputs the generated second map screen to the input/output unit 34. As described above in the explanation of FIG. 5 (A52 in FIG. 5), the second map screen includes a road map image within the predetermined range (501 in FIG. 5), a GUI component indicating the report time (502 in FIG. 5), a GUI component indicating the predetermined period (503 in FIG. 5), a GUI component indicating the time (shooting time) when the on-board video was captured in the vehicle 10 corresponding to the icon selected on the first map screen (504 in FIG. 5), and a GUI component indicating a video playback start button (505 in FIG. 5) for requesting the start of playback of the on-board video captured in the vehicle 10 corresponding to the icon selected on the first map screen. After completing the process of step S107, the controller 31 executes a process of step S108.

In step S108, the controller 31 determines whether a request to play the on-board video corresponding to the icon selected in step S106 has been input to the input/output unit 34. In one example, the controller 31 determines whether an operation to press a video playback start button on the second map screen has been input to the input/output unit 34. When a request to play the on-board video corresponding to the icon selected in step S106 has not been input to the input/output unit 34 (a negative determination in step S108), the controller 31 executes the process of step S106 again. At that time, if the operator selects an icon different from the previous icon, controller 31 changes the shooting time (504 in FIG. 5) displayed on the second map screen to the shooting time corresponding to the newly selected icon. Furthermore, in step S108, if a request to play the on-board video corresponding to the icon selected in step S106 has been input to the input/output unit 34 (positive determination in step S108), the controller 31 executes the process of step S109.

In step S109, the controller 31 generates a second request signal in accordance with the icon selected in step S106, and transmits the generated second request signal to the server 2. The second request signal at this time includes the vehicle ID registered in the vehicle ID field of the record corresponding to the icon selected in step S106 from among the records included in the vehicle list received in step S104, and the date and time ID registered in the date and time ID field of this record. After completing the process of step S109, the controller 31 executes a process of step S110.

In step S110, the controller 31 receives, via the communication I/F 33, the on-board video file transmitted from the server 2 in response to the second request signal. After completing the process of step S110, the controller 31 executes a process of step S111.

In step S111, the controller 31 plays back the on-board video file received in step S110. The on-board video file to be played may be output via the input/output unit 34. When the controller 31 has finished executing the process of step S111, the controller 31 ends the execution of the processing routine of FIG. 6.

According to the embodiment described above, the terminal 3 can display the first map screen on which the occurrence location is mapped, using the reception of the first information as a trigger. This enables the operator of the terminal 3 quickly to grasp the location relationship between the occurrence location and the vehicles that have been traveling in the vicinity (within a predetermined range) of the occurrence location point within a predetermined period including the report time. As a result, the operator can easily identify the vehicle 10 that is likely to have photographed the occurrence location. Then, by selecting the icon of the identified vehicle 10, the operator can check the on-board video that may capture the scene where the abnormal event occurred.

Therefore, according to the present embodiment, it is possible to reduce the time and effort required to check the on-board video that may capture the scene where the abnormal event occurred. This improves the convenience for the operator who uses the monitoring system.

### Others

The above-described embodiment is merely an example, and the present disclosure can be modified and implemented as appropriate without departing from the spirit and scope of the present disclosure. For example, the processes and configurations described in this disclosure can be freely combined and implemented as long as no technical contradictions arise. In addition, in the embodiment, a vehicle equipped with an in-vehicle apparatus is exemplified, but a moving object other than a vehicle may be used as long as it is capable of capturing an image.

Furthermore, the processes described as being performed by one apparatus may be shared and executed by a plurality of apparatuses. Alternatively, the processes described as being performed by different apparatuses may be performed by a single apparatus. For example, in the above embodiment, the terminal 3 generates a first map screen based on the vehicle list received from the server 2 and displays the generated first map screen on the input/output unit 24, but the first map screen may also be generated by the server 2. That is, instead of the server 2 generating the vehicle list and transmitting it to the terminal 3, the server 2 may generate the first map screen. In this case, the first map screen generated by the server 2 may be transmitted to the terminal 3, and the terminal 3 may output it. That is, the function of the terminal 3 described in the embodiment may be provided in the server 2. In this manner, the information processing apparatus according disclosure can be realized as the server 2 or as the terminal 3. In a computer system, the hardware configuration for implementing each function can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a communication network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus comprising controller configured to execute processing of:
displaying on a map a plurality of icons indicating positions of each vehicle at a plurality of times based on travelling history of one or more vehicles; and
transmitting, when one of the plurality of icons is selected, a command to a vehicle corresponding to the selected icon to transmit an image captured at a time corresponding to the selected icon,
wherein, the controller is further configured to execute processing of:
acquiring a first information regarding a report from a predetermined administrative agency that has received the report regarding an occurrence of an abnormal event; and
displaying on the map a location where the abnormal event is estimated to have occurred based on the first information.

2. The information processing apparatus according to the claim 1, wherein,
the first information includes voice data of a conversation regarding the report between a informant and the predetermined administrative agency,
the controller identifies a location where the abnormal event is estimated to have occurred by analyzing the voice data using a predetermined language model.

3. The information processing apparatus according to the claim 2, wherein,
the predetermined language model is a language model trained by voice when the predetermined administrative agency receives the report.

4. An information processing method may be comprising following processing performed by a computer:
displaying on a map a plurality of icons indicating positions of each vehicle at a plurality of times based on travelling history of one or more vehicles; and
transmitting, when one of the plurality of icons is selected, a command to a vehicle corresponding to the selected icon to transmit an image captured at a time corresponding to the selected icon,
wherein, further comprising following processing performed by the computer:
acquiring a first information regarding a report from a predetermined administrative agency that has received the report regarding an occurrence of an abnormal event; and
displaying on the map a location where the abnormal event is estimated to have occurred based on the first information.

5. A non-transitory storage medium storing a program configured to cause a computer to execute processing of:
displaying on a map a plurality of icons indicating positions of each vehicle at a plurality of times based on travelling history of one or more vehicles; and
transmitting, when one of the plurality of icons is selected, a command to a vehicle corresponding to the selected icon to transmit an image captured at a time corresponding to the selected icon,
wherein, the program is further configured to cause the computer to execute processing of:
acquiring a first information regarding a report from a predetermined administrative agency that has received the report regarding an occurrence of an abnormal event; and
displaying on the map a location where the abnormal event is estimated to have occurred based on the first information.
